(19) United States
(12) Patent Application Publication
(10) Pub. No.: US 2003/0225848 A1
(43) Pub. Date: Dec. 4, 2003

(54) Remote instant messaging personalization items

(76) Inventors: Brian Heikes, Ashburn, VA (US); James A. Odell, Potomac Falls, VA (US); Justin Uberti, Sterling, VA (US); Andrew L. Wick, McLean, VA (US); Xiaoyan Yin, Fairfax Station, VA (US); Xiaopeng Zhang, Oak Hill, VA (US)

Correspondence Address: FISH & RICHARDSON P.C., 1425 K STREET, N.W., 11TH FLOOR, WASHINGTON, DC, 20005-3500, US

(21) Appl. No.: 10/334,129

(22) Filed: Dec. 31, 2002

Related U.S. Application Data
(63) Continuation-in-part of application No. 10/305,015, filed on Nov. 27, 2002.
(60) Provisional application No. 60/384,147, filed on May 31, 2002.
(60) Provisional application No. 60/416,902, filed on Oct. 9, 2002.

(51) Int. Cl. G06F 15/16

(52) U.S. Cl. 709/207

(57) ABSTRACT

Perception of a personalization item in an instant messaging communications session may be enabled by storing on a host system one or more personalization items associated with an instant messaging application operator, receiving a request from an instant messaging participant system for the personalization items associated with the instant messaging application operator, accessing the personalization items at the host system, and communicating the personalization items from the host system to the instant messaging participant system for rendering in an instant messaging application running on the instant messaging participant system.

This application claims priority from U.S. Provisional Application No. 60/384,147, filed May 31, 2002, and U.S. Provisional Application No. 60/416,902, filed Oct. 9, 2002, and is a continuation-in-part of U.S. application Ser. No. 10/305,015, filed Nov. 27, 2002, all of which are incorporated by reference.

### TECHNICAL FIELD

This description relates to instant messaging communications and more particularly to personalization of instant messaging communications for an instant message application operator (hereinafter “IM sender”).

### BACKGROUND

Online service providers facilitate access to information and services by providing interactive User Interfaces (UIs) that help users navigate to desired resources. For example, in the case of a system for communicating using instant messages (IMs), a UI allows an IM sender to invoke actions, such as establishing a communications link, through the selection of screen objects such as icons, windows, and drop-down menus. The design of a UI has a significant impact on an IM sender's online experience. In particular, the icons, the windows, and the menus of a UI may be arranged to enable an IM sender to locate information and services quickly and easily.

### SUMMARY

In one general aspect, perception of a personalization item in an instant messaging communications session may be enabled by storing on a host system one or more personalization items associated with an instant messaging application operator, receiving a request from an instant messaging participant system for the personalization items associated with the instant messaging application operator, accessing the personalization items at the host system, and communicating the personalization items from the host system to the instant messaging participant system for rendering in an instant messaging application running on the instant messaging participant system.

Implementations may include one or more of the following features. For example, the request may also include an identity of the instant messaging participant, and the personalization items associated with the received identity may be accessed. The request may also include an identifier that enables identification of a personalization item associated with the instant messaging application operator. The identifier may include a location on the host system of the personalization item, an item type and a data size, a custom item flag, an official item flag, a banned item flag, or a redirect to different item flag. The identifier for a personalization item may be created based upon the application of an algorithm to at least a portion of item data. Based on the identifier, if it is determined that the personalization item is already stored at the host, then the host may decline to redundantly store the personalization item. Also, the identifier may be used to determine whether the personalization item is an official item, and the personalization item may be displayed if it is an official item.

The host may be a server authorized as a partner to an instant messaging host. The personalization items stored at the host include a graphic, such as an icon, a sound, wallpaper capable of being rendered on an instant messaging application user interface, an animation sequence, and a video segment.

The personalization items may be configured to expire upon the occurrence of a predetermined event, such as the passage of a predetermined length of time or the passage of a predetermined date, or a predetermined number of uses. If it is determined that the personalization item has expired, access to the personalization item may be disallowed. If it is determined that the personalization item has been banned, access to the personalization item may be disallowed.

In another general aspect, perception of a personalization item in an instant messaging communications session may be enabled by rendering, on an instant messaging participant system, an instant messaging application user interface for an instant messaging communications session involving at least an instant messaging application operator and another instant messaging participant, identifying personalization items associated with the instant messaging application operator that are located external to the instant messaging participant system, and communicating personalization items associated with the instant messaging application operator to the instant messaging participant system.

Implementations may include one or more of the following features. For example, identifying the personalization items includes identifying a remote source location for the personalization items. The personalization items may be located on an instant messaging host. Personalization items include a graphic, such as an icon, a sound, wallpaper capable of being rendered on an instant messaging application user interface, an animation sequence, a video segment, and a customized binary object uploaded by the instant messaging participant to a server. The personalization item may be enabled to be rendered in consideration of a payment for such rendering, and may be configured to expire upon the occurrence of a predetermined event such as the passage of a predetermined length of time or the passage of a predetermined date, or a predetermined number of uses. If it is determined that the personalization item has expired, display of the personalization item may be disallowed. If it is determined that the personalization item has been banned, display of the personalization item may be disallowed. The personalization item may be updated.

Communicating the personalization items may include obtaining an identifier enabling identification of a personalization item associated with the instant messaging application operator, obtaining the personalization item from a source other than a message used to obtain the identifier, and rendering the personalization item at the instant messaging participant system.

Obtaining the identifier includes sending an identity of the instant messaging participant to an instant messaging host system and receiving one or more identifiers in a message from the instant messaging host system, the identifiers being associated at the instant messaging host system with one or more personalization items, where the personalization items are associated with the identity of the instant messaging participant. Obtaining the identifier also includes retrieving the identifier from a remote data store or receiving the identifier upon a change in a presence state of the instant messaging participant. The location of the personalization item may be obtained with the identifier. The identifier may include an item type, a data size, a custom item flag, an official item flag, a banned item flag, or a redirect to a different item flag.

Obtaining the personalization item includes obtaining an identifier enabling identification of a personalization item associated with the instant messaging application operator, determining whether the personalization item associated with the received identifier is available at the instant messaging participant system, retrieving the personalization item from the instant messaging participant system if the personalization item is available at the instant messaging participant system, and requesting the personalization item from a remote source and receiving the personalization item from the remote source at the instant messaging participant system if the personalization item is not available at the instant messaging participant system.

Requesting the personalization item may include identifying the remote source. Also, the personalization item may be requested from an instant messaging host.

An identifier for a personalization item may be created based upon the application of an algorithm to at least a portion of the item data. The identifier may be created, for example, for a personalization item stored at the instant message participant system. If it is determined, based on the identifier, that the personalization item is stored at the host system, the host may decline to redundantly store the personalization item. Also, if it is determined based on the identifier that the personalization item is an official item, then the personalization item may be displayed.

The personalization item may include any of the items noted above. The personalization item may be provided by a third party, and may be enabled to be rendered in consideration of a payment. The personalization item also may be configured to expire upon the occurrence of a predetermined event such as, for example, the passage of a predetermined length of time, the passage of a predetermined date, or a predetermined number of uses.

Aspects of the IM personalization may be implemented by an apparatus and/or by a computer program stored on a computer readable medium. The computer readable medium may comprise a disc, a client device, a host device, and/or a propagated signal. In addition, aspects of the IM personalization may be implemented in a client/host context or in a standalone or offline client device. The IM personalization items may be rendered in a client/host context and may be accessed or updated through a remote device in a client/host environment. The IM personalization items also may be rendered by the standalone/offline device and may be accessed or updated through a remote device in a non-client/host environment such as, for example, a LAN server serving an end user or a mainframe serving a terminal device.

Other features will be apparent from the following description, including the drawings, and from the claims.

### DESCRIPTION OF DRAWINGS

FIGS. 1-4 are block diagrams of an exemplary communications system.

FIG. 5 is a flow chart of an exemplary process that may be implemented by systems such as those of FIGS. 1-4.

FIGS. 6-9 are illustrations of different graphical user interfaces that may be implemented by systems such as those of FIGS. 1-4 when executing a process such as that of FIG. 5.

FIGS. 10 and 16 are flow charts of exemplary processes that may be implemented by systems such as those of FIGS. 1-4.

FIGS. 11-15 are illustrations of different graphical user interfaces that may be implemented by systems such as those of FIGS. 1-4 when executing processes such as those of FIGS. 10 and 16.

Like reference symbols in the various drawings indicate like elements. For brevity, several elements in the figures described below are represented as monolithic entities. However, as would be understood by one skilled in the art, these elements each may include numerous interconnected computers and components designed to perform a set of specified operations and/or may be dedicated to a particular geographic region.

### DETAILED DESCRIPTION

It is possible, through the systems and techniques described herein, to make personalization items perceivable to an IM sender in a communications interface, when, for example, the IM sender opens the interface. Personalization items may represent the IM sender or a characteristic of the IM sender, and may include user-selectable binary objects. For example, personalization items include images, such as wallpaper, that are rendered in a location having a contextual placement on a user interface. The contextual placement typically indicates an association with the user represented by the wallpaper. For example, the wallpaper may be rendered in an area where messages from the IM sender are displayed, or as a chrome (i.e., border) around a dialog area on a user interface. Personalization items also include icons such as buddy icons and mini-buddy icons, sounds, animation, video clips, and emoticons (e.g., smileys).

One or more personalization items may be rendered at the IM sender system. IM sender personalization items are associated with and made available to the IM sender system based on one or more identifiers corresponding to the personalization items. An identifier may be associated with a single personalization item, or with a group of two or more personalization items. For instance, an identifier may identify a particular personalization item, a group of personalization items, or a user name or other identifier that may be mapped to one or more personalization items or groups.

The IM sender system may use the identifier to identify one or more associated personalization items, and to locate perceivable content corresponding to the identifier. For instance, an identifier may be used as a basis for determining if one or more corresponding personalization items are available locally at the IM sender system, and, if so, the identifier may be used to retrieve the corresponding personalization item(s). If the personalization items are not available locally at the IM sender system, the IM sender system may use the identifier as a basis for generating one or more requests for the personalization item(s) from another location, such as an IM host system or another remotely-accessible data store such as a remote or third-party server (e.g., a server accessible through the Internet).

Identifiers may be retrieved before, during, or after receipt of an instant message from an IM participant (hereinafter “IM recipient”). The IM sender system may retrieve the identifiers from a remote location such as an IM host system or another remotely accessible data store such as those noted above. The identifiers may be stored at the remote location and associated with a screen name or other user identity of the IM sender. The IM sender system may send a screen name or other user identity to the remote location where it is associated with the corresponding identifiers, and may receive those identifiers from the IM remote location. In another implementation, the IM host system or other remotely accessible data store may retrieve and send the personalization items themselves rather than the identifiers.

Personalization items may be made available to the IM sender system and rendered at the IM sender system based on a selection process. The personalization items may be selected manually by the IM sender or they may be automatically selected for the IM sender. Identifiers for selected personalization items then may be associated with a screen name or other identifying information for the IM sender. For example, the identifiers may be associated with the screen name of the IM sender and stored locally at the IM sender system, or the IM sender system may retrieve the identifiers associated with the screen name of the IM sender from another location such as the IM host system or another remotely-accessible data store such as those noted above.

A personalization item may be rendered at any time. Typically, a personalization item is rendered upon the occurrence of one or more particular events. For example, a customized sound and/or a personalized icon or wallpaper selected by an IM sender may be made perceivable to the IM sender during the opening of a communications interface. As another example, a particular sound is played or an icon is displayed at the IM sender system when changes are experienced in the presence or state of the IM sender or another IM participant with whom they communicate (e.g., when the IM sender or other participant logs on, logs off, becomes inactive, or enables or disables an IM recipient's ability to detect the IM sender's presence).

Typically, IM communications involve an instantaneous or nearly instantaneous communication between two users, where each user is able to transmit, receive and display communicated information. Additionally, although IM communications may occur in the absence of online presence information, IM communications generally involve the display and perception of online presence information regarding other selected users (“buddies”). IM communications may be machine-to-machine communications that occur without intervention by or communication through an instant messaging server after a communication session is established or authentication is performed. Examples of IM communications exist over AIM (America Online Instant Messenger), AOL (America Online) Buddy List and Instant Messages, Yahoo Messenger, MSN Messenger, and ICQ, among others. Although discussed below primarily with respect to IM applications, other implementations are contemplated for providing similar functionality in platforms and online applications such as chat, e-mail, and streaming media applications.

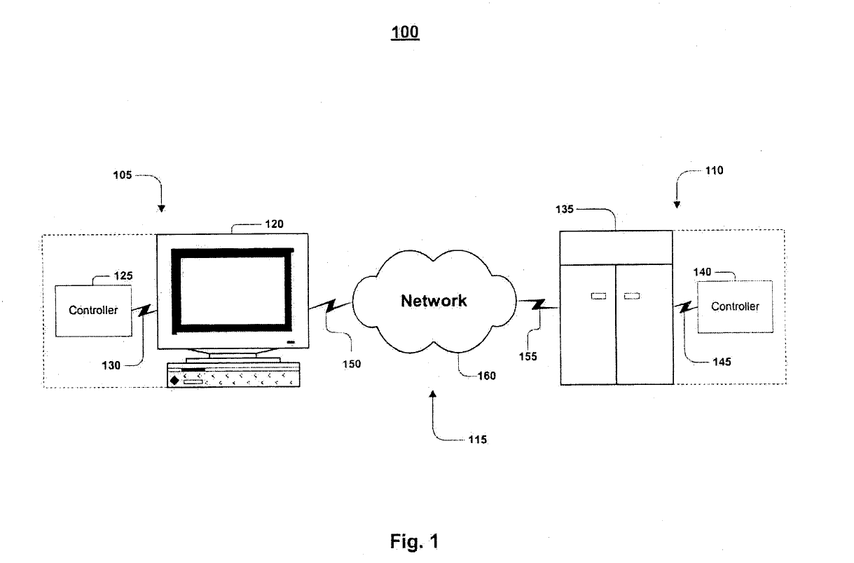

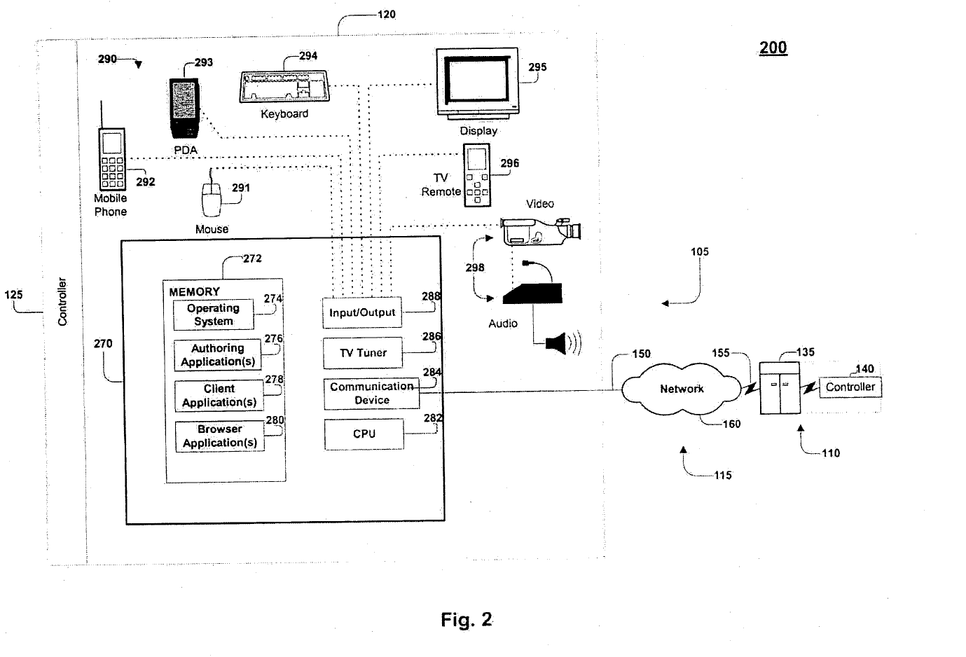

For illustrative purposes, FIGS. 1 and 2 show an example of a communications system for implementing techniques for transferring electronic data.

Referring to FIG. 1, a communications system 100 is capable of delivering and exchanging data between an IM sender system 105 and a host system 110 through a communications link 115. The IM sender system 105 typically includes one or more client devices 120 and/or client controllers 125, and the host system 110 typically includes one or more host devices 135 and/or host controllers 140. For example, the IM sender system 105 or the host system 110 may include one or more general-purpose computers (e.g., personal computers), one or more special-purpose computers (e.g., devices specifically programmed to communicate with each other and/or the IM sender system 105 or the host system 110), or a combination of one or more general-purpose computers and one or more special-purpose computers. The IM sender system 105 and the host system 110 may be arranged to operate within or in concert with one or more other systems, such as, for example, one or more LANs (“Local Area Networks”) and/or one or more WANs (“Wide Area Networks”).

The client device 120 and the host device 135 are generally capable of executing instructions under the command of, respectively, a client controller 125 and a host controller 140. The client device 120 and the host device 135 are connected to, respectively, the client controller 125 and the host controller 140 by, respectively, wired or wireless data pathways 130 and 145, which are capable of delivering data.

The client device 120, the client controller 125, the host device 135, and the host controller 140 typically each include one or more hardware components and/or software components. An example of a client device 120 or a host device 135 is a general-purpose computer (e.g., a personal computer) or software on such a computer capable of responding to and executing instructions in a defined manner. Other examples include a special-purpose computer, a workstation, a server, a device, a component, other physical or virtual equipment or some combination of these capable of responding to and executing instructions. The client device 120 and the host device 135 may include devices that are capable of establishing peer-to-peer communications.

An example of client controller 125 or host controller 140 is a software application loaded on the client device 120 or the host device 135 for commanding and directing communications enabled by the client device 120 or the host device 135. Other examples include a program, a piece of code, an instruction, a device, a computer, a computer system, or a combination of these for independently or collectively instructing the client device 120 or the host device 135 to interact and operate as described. The client controller 125 and the host controller 140 may be embodied permanently or temporarily in any type of machine, component, physical or virtual equipment, storage medium, or propagated signal capable of providing instructions to the client device 120 and the host device 135.

The communications link 115 typically includes a delivery network 160 that provides direct or indirect communication between the IM sender system 105 and the host system 110, irrespective of physical separation. Examples of a delivery network 160 include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. The communications link 115 may include communication pathways 150 and 155 that enable communications through the one or more delivery networks 160 described above. Each of the communication pathways 150 and 155 may include, for example, a wired, wireless, cable or satellite communication pathway.

FIG. 2 illustrates a communications system 200 including an IM sender system 105 communicating with a host system 110 through a communications link 115.

The IM sender system 105 includes a client device 120 that typically includes a general-purpose computer 270 having an internal or external memory 272 for storing data and programs such as an operating system 274 (e.g., DOS, Windows™, Windows 95™, Windows 98™, Windows 2000™, Windows Me™, Windows XP™, Windows NT™, OS/2, or Linux) and one or more application programs. Examples of application programs include authoring applications 276 (e.g., word processing programs, database programs, spreadsheet programs, or graphics programs) capable of generating documents or other electronic content; client applications 278 (e.g., America Online (AOL) client, CompuServe client, AOL Instant Messenger (AIM) client, interactive television (ITV) client, Internet Service Provider (ISP) client, or instant messaging (IM) client) capable of communicating with other computer users, accessing various computer resources, and viewing, creating, or otherwise manipulating electronic content; and browser applications 280 (e.g., Netscape's Navigator or Microsoft's Internet Explorer) capable of rendering standard Internet content and other content formatted according to standard protocols such as the Hypertext Transfer Protocol (HTTP).

One or more of the application programs may be installed on the internal or external storage 272 of the general-purpose computer 270. Alternatively, in another implementation, the client controller 125 may access application programs externally stored in and/or performed by one or more device(s) external to the general-purpose computer 270.

The general-purpose computer 270 also includes a central processing unit 282 (CPU) for executing instructions in response to commands from the client controller 125, and a communication device 284 for sending and receiving data. One example of the communication device 284 is a modem. Other examples include a transceiver, a set-top box, a communication card, a satellite dish, an antenna, a network adapter, or some other mechanism capable of transmitting and receiving data over the communications link 115 through a wired or wireless data pathway 150. The general-purpose computer 270 optionally includes a television (“TV”) tuner 286 for receiving television programming in the form of broadcast, satellite, and/or cable TV signals. The TV tuner 286 permits the client device 120 to selectively and/or simultaneously display network content received by communications device 284 and TV programming content received by the TV tuner 286.

The general-purpose computer 270 may include an input/output interface 288 that enables wired or wireless connection to various peripheral devices 290. Examples of peripheral devices 290 include, but are not limited to, a mouse 291, a mobile phone 292, a personal digital assistant (PDA) 293, an MP3 player (not shown), a keyboard 294, a display monitor 295 with or without a touch screen input, a TV remote control 296 for receiving information from and rendering information to users, and an audiovisual input device 298.

Although FIG. 2 illustrates devices such as a mobile telephone 292, a PDA 293, and a TV remote control 296 as being peripheral with respect to the general-purpose computer 270, in another implementation, such devices may themselves include the functionality of the general-purpose computer 270 and operate as the client device 120. For example, the mobile phone 292 or the PDA 293 may include computing and networking capabilities and function as a client device 120 by accessing the delivery network 160 and communicating with the host system 110. Furthermore, the IM sender system 105 may include one, some or all of the components and devices described above.

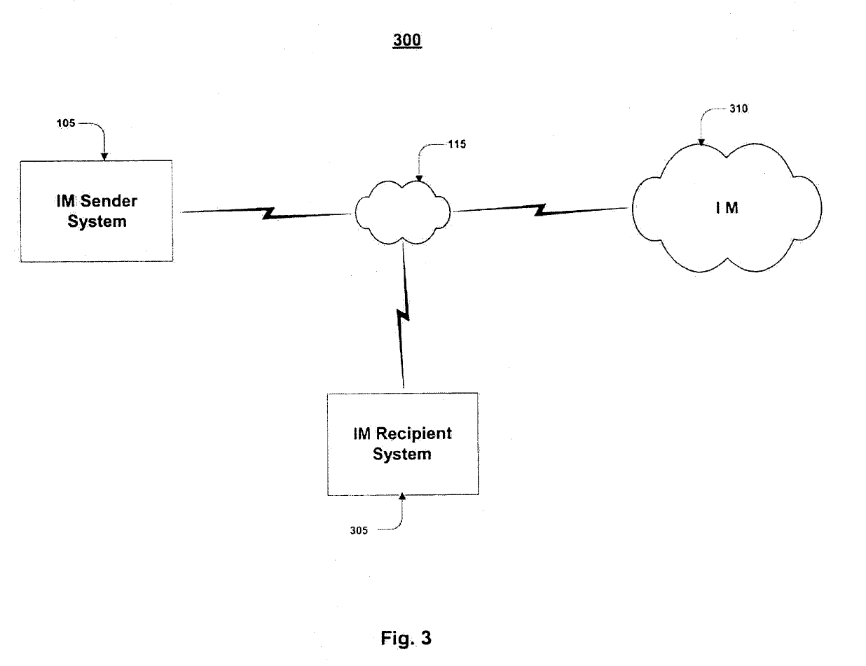

FIG. 3 illustrates a communications system 300 including an IM sender system 105 communicating with an IM recipient system 305 and an IM host system 310 through a communication link 115. Such a communications system may be used by users of IM service providers, such as, for example, AIM, ICQ, Yahoo Messenger, and Microsoft Messenger.

In one implementation, the IM host system 310 may have characteristics similar to those described above with respect to the host system 110, the IM recipient system 305 may have characteristics similar to those described above with respect to the IM sender system 105, and the IM sender system 105 and the IM recipient system 305 may include communication software to enable users of the client systems to access the IM host system 310.

The IM host system 310 may support IM services irrespective of an IM sender's network or Internet access. Thus, the IM host system 310 may allow users to send and receive IMs, regardless of whether they have access to any particular ISP. The IM host system 310 also may support associated services, such as administrative matters, advertising, directory services, chat, and interest groups related to the IM. The IM host system 310 has an architecture that enables the devices (e.g., servers) within the IM host system 310 to communicate with each other. To transfer data, the IM host system 310 employs one or more standard or exclusive IM protocols.

To access the IM host system 310 to begin an IM session in the implementation of FIG. 3, the IM sender system 105 establishes a connection to the IM host system 310. Once a connection to the IM host system 310 has been established, the IM sender system 105 may directly or indirectly transmit data to and access content from the IM host system 310. By accessing the IM host system, an IM sender can use the IM client application to view whether particular users (“buddies”) are online, exchange IMs with particular buddies, participate in group chat rooms, trade files such as pictures, invitations or documents, find other buddies with similar interests, get customized information such as news and stock quotes, and search the Web. IM recipient system 305 may be similarly manipulated to establish contemporaneous connection with IM host system 310.

Once connectivity is established, an IM sender who is using IM sender system 105 may view whether an IM recipient using IM recipient system 305 is online, and typically may view whether the IM recipient is able to receive IMs. If the IM recipient is online, the IM sender may exchange IMs with the IM recipient.

In one implementation, the IMs sent between IM sender system 105 and IM recipient system 305 are routed through IM host system 310. In another implementation, the IMs sent between IM sender system 105 and IM recipient system 305 are routed through a third party server (not shown), and, in some cases, are also routed through IM host system 310. In yet another implementation, the IMs are sent directly between IM sender system 105 and IM recipient system 305.

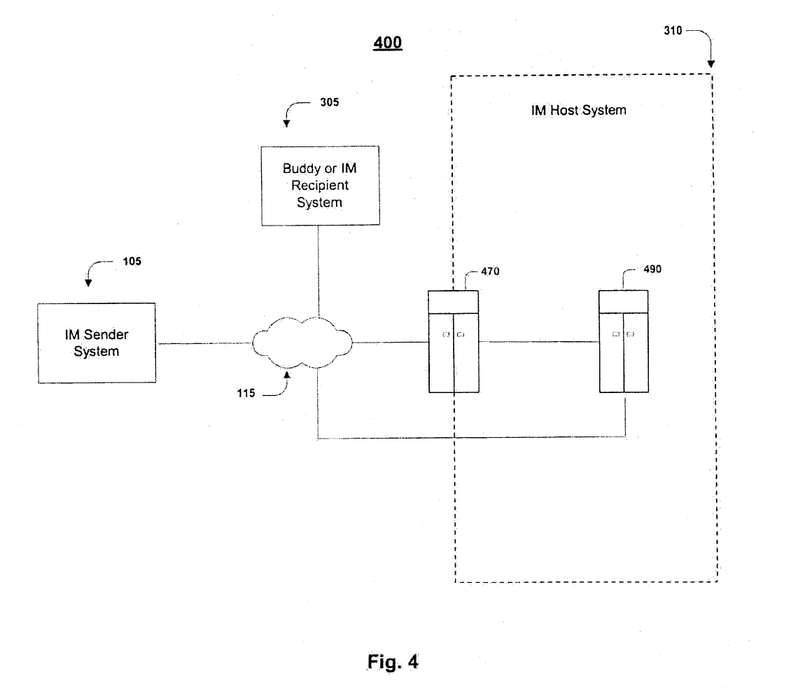

FIG. 4 illustrates a communications system 400 including an IM sender system 105 communicating with an IM recipient system 305 and an IM host system 310 through a communication link 115. System 400 illustrates a possible implementation of the communications system 300 of FIG. 3.

In system 400, the IM host system 310 includes a login server 470 for enabling access by users and routing communications between the IM sender system 105 and other elements of the IM host system 310. The IM host system 310 also includes an IM server 490. To enable access to and facilitate interactions with the IM host system 310, the IM sender system 105 and the IM recipient system 305 may include communication software, such as for example, an OSP client application and/or an IM client application.

As described with respect to FIG. 3, the IM host system 310 may support IM services irrespective of an IM sender's network or Internet access. Thus, the IM host system 310 may allow users to send and receive IMs, regardless of whether they have access to any particular ISP. The IM host system 310 also may support associated services, such as administrative matters, advertising, directory services, chat, and interest groups related to the IM. The IM host system 310 has an architecture that enables the devices (e.g., servers) within the IM host system 310 to communicate with each other. To transfer data, the IM host system 310 employs one or more standard or exclusive IM protocols.

In one implementation, the IM sender system 105 establishes a connection to the login server 470 in order to access the IM host system 310 and begin an IM session. The login server 470 typically determines whether the particular IM sender is authorized to access the IM host system 310 by verifying the IM sender's identification and password. If the IM sender is authorized to access the IM host system 310, the login server 470 usually employs a hashing technique on the IM sender's screen name to identify a particular IM server 490 within the IM host system 310 for use during the IM sender's session. The login server 470 provides the IM sender (e.g., IM sender system 105) with the IP address of the IM server 490, gives the IM sender system 105 an encrypted key, and breaks the connection. The IM sender system 105 then uses the IP address to establish a connection to the particular IM server 490 through the communications link 115, and obtains access to the IM server 490 using the encrypted key. Typically, the IM sender system 105 will be able to establish an open TCP connection to the IM server 490. The IM recipient system 305 establishes a connection to the IM host system 310 in a similar manner.

In one implementation, the IM sender system 105 may directly or indirectly transmit data to and access content from the IM server 490 once a connection to the IM server 490 has been established. By accessing the IM server, an IM sender can leverage the IM client application to determine whether particular users (“buddies” or potential IM recipients) are online, exchange IMs with particular buddies, participate in group chat rooms, trade files such as pictures, invitations or documents, find other buddies with similar interests, get customized news and stock quotes, and search the Web. For example an IM sender who is using IM sender system 105 may view whether a buddy using IM recipient system 305 is online, and if so, may exchange IMs with that buddy. In one implementation, the IMs sent between IM sender system 105 and IM recipient system 305 are routed through IM host system 310. In another implementation, the IMs sent between IM sender system 105 and IM recipient system 305 are routed through a third party server (not shown) and, in some cases, are also routed through IM host system 310. In yet another implementation, the IMs are sent directly between IM sender system 105 and IM recipient system 305.

In one implementation, the IM host system 310 also includes a user profile server (not shown) connected to a database (not shown) for storing large amounts of user profile data. The user profile server may be used to enter, retrieve, edit, manipulate, or otherwise process user profile data. In one implementation, an IM sender's profile data includes, for example, the IM sender's screen name, buddy list, identified interests, and geographic location. The IM sender's profile data may also include personalization items selected by the IM sender. The IM sender may enter, edit and/or delete profile data using an installed IM client application on the IM sender system 105 to interact with the user profile server.

Because the IM sender's data are stored in the IM host system 310, the IM sender does not have to reenter or update such information in the event that the IM sender accesses the IM host system 310 using a new or different IM sender system 105. Accordingly, when an IM sender accesses the IM host system 310, the IM server can instruct the user profile server to retrieve the IM sender's profile data from the database and to provide, for example, the IM sender's personalization items and buddy list to the IM server. Alternatively, user profile data may be saved locally on the IM sender system 105.

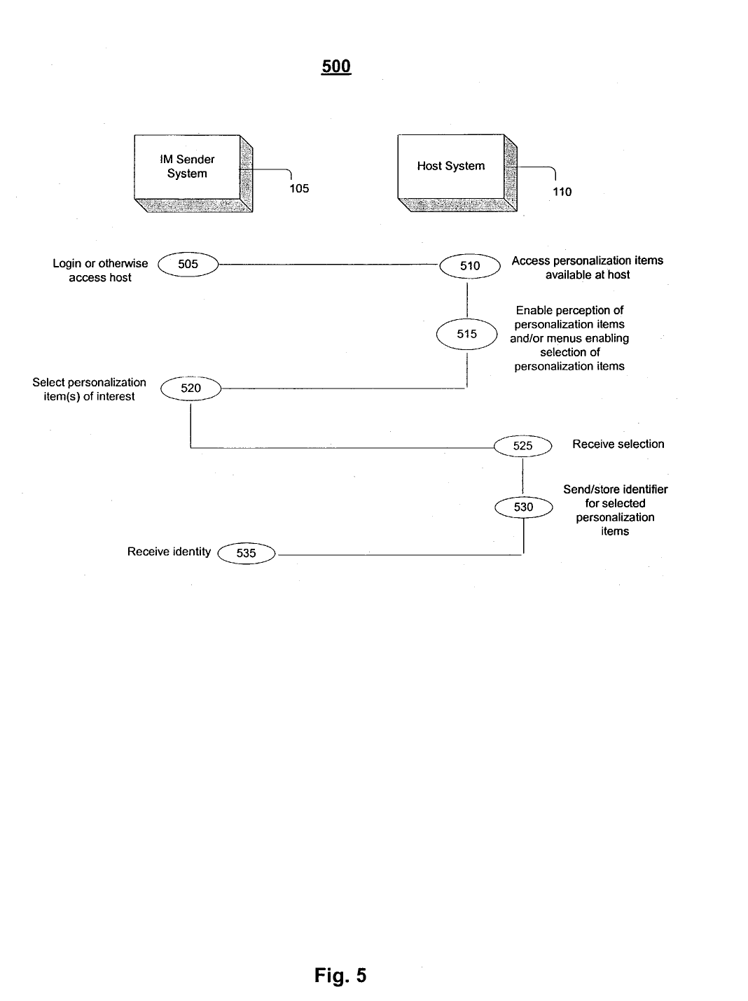

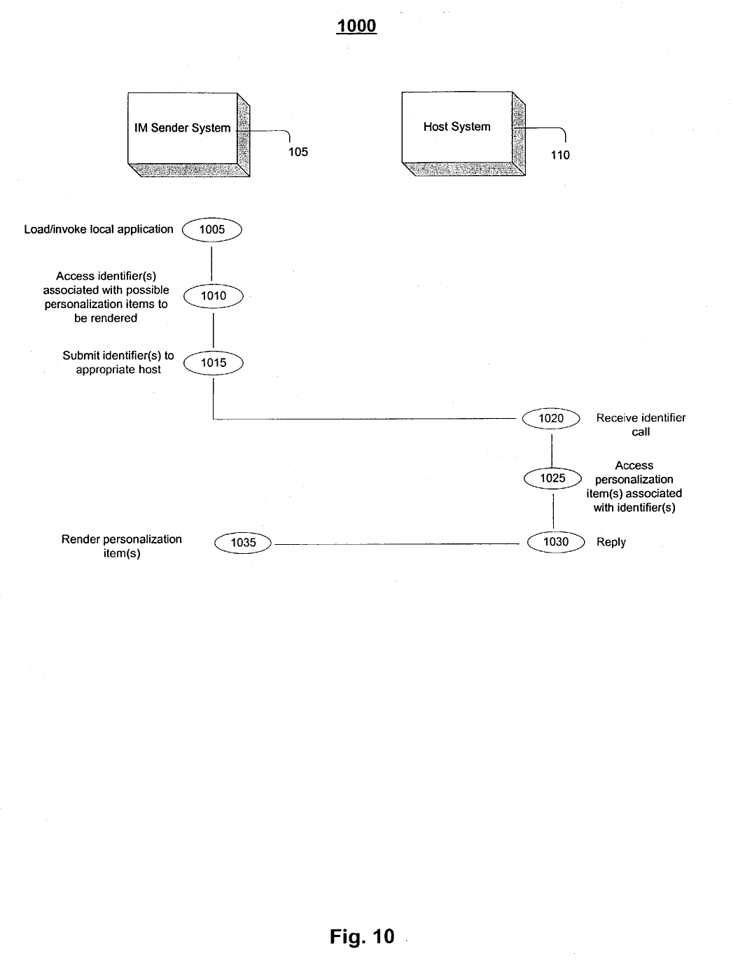

Referring to FIGS. 5 and 10 the IM sender system 105 and the host system 110 interact according to exemplary procedure 500 to enable an IM sender to select a personalization item and according to exemplary procure 1000 to make the host-based personalization item selected by the IM sender in procedure 500 perceivable to the IM sender.

Procedures 500 and 1000 may be implemented by any type of hardware, software, device, computer, computer system, equipment, component, program, application, code, storage medium, or propagated signal. Although not shown in FIGS. 5 and 10, the IM sender system 105 and the host system 110 may be directly or indirectly interconnected through known or described delivery networks, examples of which are described with respect to network 160.

The procedures 500 and 1000 may be implemented in a client/host context, or a standalone or offline client context. For example, while some functions of procedures 500 and 1000 may be performed entirely by the IM sender system 105, other functions may be performed by host system 110, or the collective operation of the IM sender system 105 and the host system 110. The host system 110 is a computer remote to the instant messaging operator systems, and may be, for example, an IM host system 310. In procedures 500 and 1000, the personalization item may be respectively selected and rendered by the standalone/offline device, and the personalization item may be accessed or updated through a remote device in a non-client/host environment such as, for example, a LAN server serving an end user or a mainframe serving a terminal device.

Thus, the procedures 500 and 1000 described below may be implemented for any OSP, ISP, browser and/or other software program having a graphical user interface, such as programs for instant messaging, chat, electronic mail and stand-alone browsers.

Procedure 500 generally involves selecting a personalization item. In the procedure 500, the IM sender system 105 logs in or otherwise accesses the host system 110 (step 505). For instance, IM sender system 105 may connect to the host system 110 across a network (e.g., network 160) by supplying verifiable credentials to a server (e.g., a login server) at the host system 110. More specifically, a browser may be used to access a web-available interface, an instant message may be used to access a selectable interface, or an IM client that has an interface to a host may be used, among other options.

The host system 110 accesses personalization items available at the host for selection by the IM sender system 105 (step 510). In one implementation, the host system 110 may use a screen name of the IM sender system 105 or another identification of the IM sender system 105 to select/identify personalization items available to the IM sender system 105.

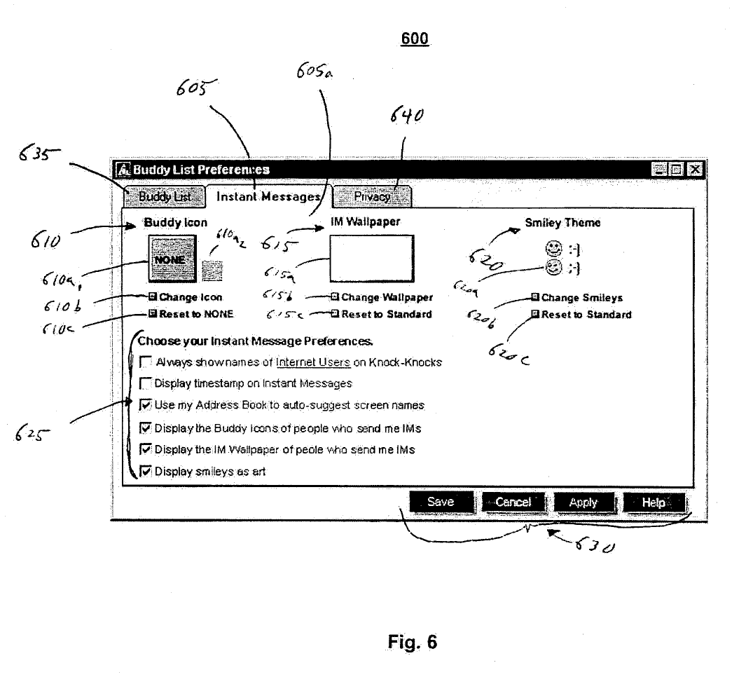

Next, the host system 110 enables perception by the IM sender system 105 of personalization items and/or menus enabling the selection of personalization items (step 515). FIGS. 6-9 describe various interfaces available to the operator, which may be used to select personalization items and which will be described below. Based on the personalization items or menus provided or otherwise made perceivable to the operator of the IM sender system 105, the IM sender system selects personalization item(s) of interest (step 520).

The host system 110 receives the personalization item selection from the IM sender system 105 (step 525), associates the selection with an identifier for the selected personalization items, and sends and/or stores the identifier (step 530). The identifier typically includes information allowing the corresponding personalization item to be located and retrieved. For example, the identifier may include a location of the personalization item. The identifier also may include a type identifier that identifies the personalization item as, for example, an icon, an IM wallpaper, an emoticon, or a sound. The type identifier also may include a file format for the personalization item. The identifier may include one or more flags to indicate whether the personalization item is, for example, a custom item or an “official” item, whether the personalization item has been banned, or whether the personalization item has expired. Where appropriate, another flag may redirect the recipient to a different personalization item. The identifier may further include information concerning the size of the personalization item. The identifier may have a predetermined format and a predetermined length. The host system 110 may store the identifier(s) in a memory or other storage, either local or remote to the host system 110. The host system 110 also may send the identifier(s) to the IM sender system 105.

The IM sender may have chosen a personalization item from a location including the IM sender system 105, the host system 110, or another host system. When the IM sender chooses a personalization item that is locally stored on the IM sender system 105, an identifier may be created for the chosen personalization item based upon a hash of the item data. The identifier, when sent to the a remote location such as the host 110, may be checked to determine if the chosen personalization item is already known to the host system, and if so, whether the personalization item is designated as, for example, an official item. This allows the IM sender to select personalization items from the IM sender's own client system, but prevents the host system or other remote location from needing to store duplicate copies of the same items. Also, the host system or other remote location is able to determine if such items are specially designated as, for example, official items and may be rendered to users who desire to view only items so designated.

Finally, the IM sender system 105 receives the identifier(s) for the selected personalization items (step 535).

The relative order of steps 505-535 with respect to other steps in procedure 500, and also with respect to each other, may vary. Certain steps may be omitted entirely, as appropriate.

FIG. 6 illustrates one example of an IM sender UI 600 for enabling an IM sender to select personalization items. The UI 600 may be presented to an IM sender of an IM service provider. In general, the UI 600 is rendered on the IM sender system 105 using software stored on the IM sender system 105. The personalization items to be selected by the IM sender may be stored on the IM sender system 105, on the IM host system 310, or on a different host system 110 such as a host system of an authorized partner.

The UI 600 includes menu tabs 605, 635 and 640 that each have a corresponding menu to assist the IM sender with selecting personalization items. For example, as shown in FIG. 6, the menu 605a corresponding to menu tab 605 enables an IM sender to select personalization items including buddy icons 610, IM wallpaper 615, and smiley (i.e., emoticon) themes 620. The IM sender's current selections of buddy icon 610a₁, mini buddy icon 610a₂, IM wallpaper 615a, and smiley theme 620a are displayed. Each of these personalization items may be made available to and rendered by an IM recipient during an IM conversation with the IM sender.

A control 610b is provided for the IM sender to select a large buddy icon 610a₁, and/or a mini-buddy icon 610a₂, and a control 610c is provided to enable reset of the buddy icon selections back to a default setting (e.g., none). Another control 615b is provided to enable selection of IM wallpaper 615a, and a control 615c is provided to enable reset of the IM wallpaper selection back to a default setting. Yet another control 620b is provided to enable a smiley theme 620a, and a control 620c is provided for the IM sender to reset the smiley theme selection back to a default setting.

Other controls 625 are provided for functions such as, for example, showing the names of users who are not on a buddy list, displaying a timestamp on instant messages, using an address book to automatically suggest screen names, displaying the buddy icons of people who send instant messages to the IM sender, displaying the IM wallpaper of people who send instant messages to the IM sender, and displaying smileys as art. Controls 630 are provided for the IM sender to save the changes made, apply the changes, cancel the changes, or get help.

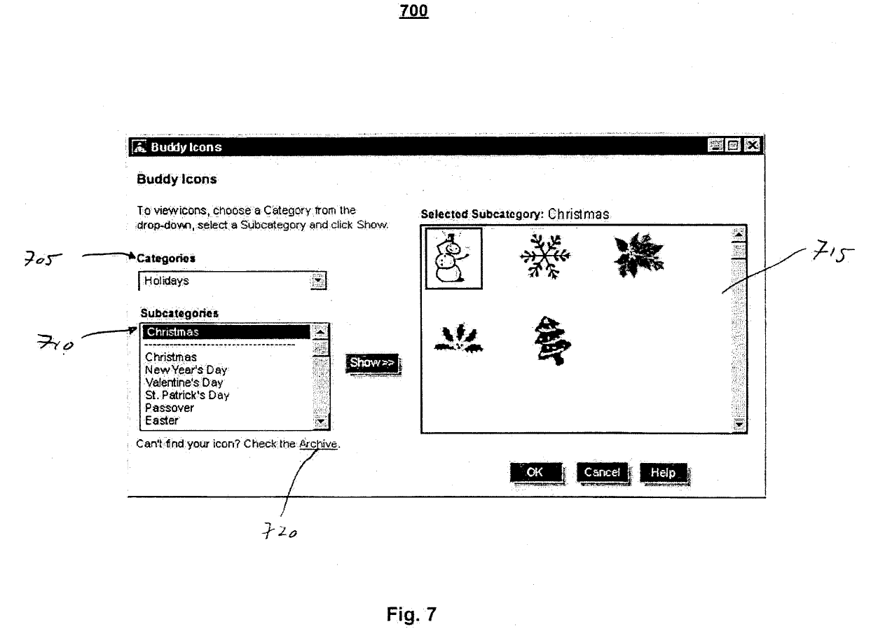

If the IM sender's personalization item selection is not available, a suitable message may be displayed to the IM sender informing the IM sender that the item is not available, and a link may be provided to an interface, such as one of the interfaces shown in FIGS. 7-9, to allow the IM sender to select a different personalization item.

FIG. 7 illustrates an example of an IM sender UI 700 for enabling an IM sender to select a buddy icon (i.e., a personalization item). The UI 700 is rendered in response to user manipulation of a control 610b (shown in FIG. 6). In the example of FIG. 7, the IM sender is presented with a list of buddy icon categories 705 and a list of subcategories 710 corresponding to the selected category. When an IM sender selects a category 705 and a subcategory 710, a window 715 displays the personalization items available in the selected subcategory. The category 705, subcategory 710, and/or the personalization items displayed in the window 715 may be host-based and remotely accessed by the IM sender. The IM sender may select a personalization item by, for example, using a mouse or other input device to make a selection among the available personalization items displayed in the window 715. Also, an archive 720 of old personalization items may be provided for IM sender selection. In another implementation, the IM sender may provide a custom buddy icon as a personalization item.

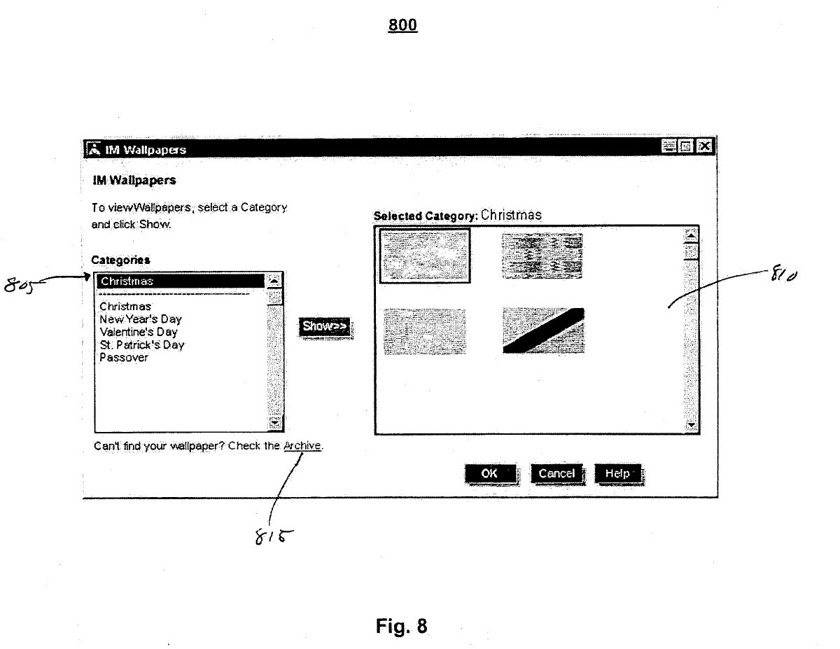

FIG. 8 illustrates an example of a UI 800 for enabling an IM sender to select IM wallpaper (i.e., a personalization item). The UI 800 is rendered in response to user manipulation of a control 615b (shown in FIG. 6). In the example of FIG. 8, the IM sender is presented with a list of IM wallpaper categories 805. When an IM sender selects a category 805, a window 810 displays the personalization items available in the selected category. The category 805 and/or the personalization items displayed in the window 810 may be host-based and remotely accessed by the IM sender. The IM sender may select a personalization item by, for example, using a mouse or other input device to select among the available items in the window 810. Also, an archive 815 of old personalization items may be provided for user selection. In another implementation, the IM sender may provide a custom IM wallpaper as a personalization item.

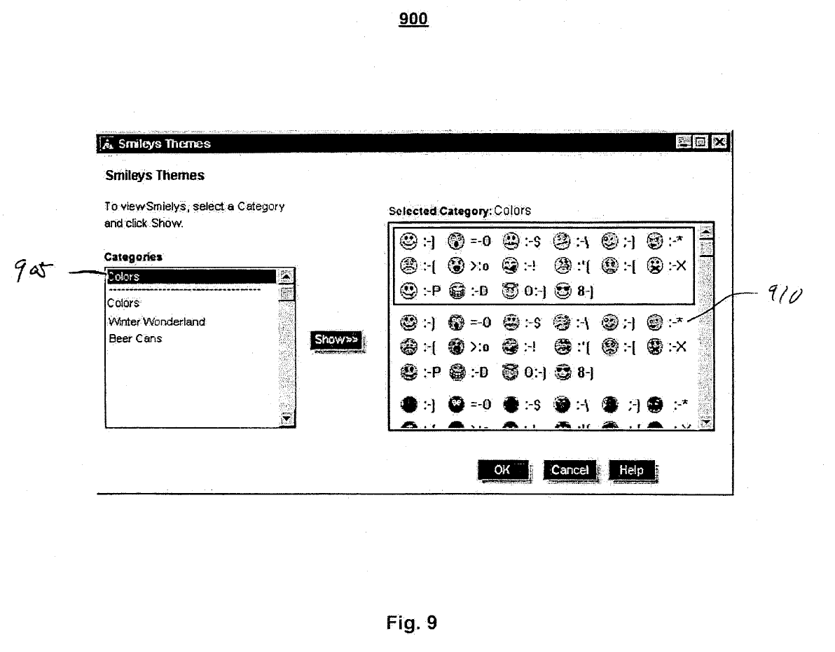

FIG. 9 illustrates an example of a UI 900 for enabling an IM sender to select smiley themes (i.e., a personalization item). The UI 900 is rendered in response to user manipulation of a control 620b (shown in FIG. 6). In the example of FIG. 9, the IM sender is presented with a list of smiley theme categories 905. When an IM sender selects a category 905, a window 910 displays the personalization items available in the selected category. The category 905 and/or the personalization items displayed in the window 910 may be host-based and remotely accessed by the IM sender. The IM sender may select a personalization item by, for example, using a mouse or other input device to make the selection among the available items in the window 910. Also, an archive of old personalization items may be provided for IM sender selection. In another implementation, the IM sender may provide a custom smiley theme as a personalization item.

As discussed with respect to FIGS. 6-9, the personalization item perception and selection may be assisted by user interfaces 600, 700, 800 and 900, which enable the IM sender to make a selection using a mouse or other input device.

Personalization item(s) may be selected manually by the IM sender or the personalization item(s) may be automatically selected for the IM sender. The IM sender personalization items may be made available to the IM sender system by obtaining one or more identifiers corresponding to the personalization items selected the IM sender. The identifiers may be associated with a screen name or other identifying information of the IM sender. For example, the identifiers may be associated with the screen name of the IM sender and stored locally at the IM sender system, or the IM sender system may retrieve the identifiers associated with the screen name of the IM sender from another location, such as a host system, including the IM host system, or another remotely accessible data store.

Referring to FIG. 10, an exemplary process 1000 may be used to render a personalization item. In procedure 1000, the IM sender system 105 loads/invokes a local application (1005). The invocation may result from user selection of the interface or it may occur automatically in response to a triggering event, such as the receipt of an instant message. Loading/invoking a local application may include invoking an application having an interfaces that renders a personalization item such as, for example, an instant messaging program having a local client or local interface (e.g., a browser).

The local application may be loaded/invoked (1005) at various times. In one implementation, a local application having personalization items to be rendered may be loaded/invoked upon literal loading of the client application. For instance, the application may be loaded or invoked without regard to whether the personalization items are being rendered in the main interface of the application or in a sub-interface of the application. In another implementation, a local application having personalization items to be rendered may be loaded/invoked only after an interface within the application is invoked that requires a host-based personalization item, even if the application itself were previously loaded/invoked. For example, an IM communications window may be invoked after the IM application has been loaded. In yet another implementation, a local application having personalization items to be rendered may be loaded/invoked upon receiving a status updated from a remote source other than the host system 110. For example, while an IM communications window/session is open, if the application is notified that the status of the remote communications has changed, the process may be invoked such that an identifier is accessed based on the received message or credentials, for example, the screen name of the party whose status has changed, and used as the basis for identifying an appropriate personalization item from the host.

In one implementation, the personalization items are not downloaded until a triggering event occurs. Once a triggering event, such as the loading of an application UI, occurs, the personalization item may be down loaded.

Next, the IM sender system 105 accesses the identifier(s) associated with possible personalization items to be rendered (step 1010). For example, where identifier(s) have been selected, received, and subsequently stored by the IM sender system 105, as described with respect to step 535 of procedure 500, they then are submitted to the appropriate host for retrieval of the personalization item(s) corresponding to the identifier(s) (step 1015). In one implementation, the IM sender system 105 requests the corresponding personalization item from the host system 110 or a location otherwise specified by or inferred from the identifier. That is, the IM sender system 105 may request the corresponding personalization item from another location such as a remote, third party server different from host system 110.

Thus, the identifier generally identifies the personalization items that reside on the host. It may do so explicitly, by referencing particular personalization items or indirect addressing for such personalization items stored elsewhere, or it may do so indirectly by referencing groups of personalization items. Where indirect, it may identify a predefined grouping, or it may instead merely identify the user specifically (e.g., a screen name) or by class (e.g., business class user to be provided business class personalization items).

Next, the host system 110 receives the identifier call from the IM sender system 105 (step 1020), and the host system accesses the personalization item(s) associated with the identifier(s) (step 1025). Where indirect personalization item identifiers are used, the host system 110 uses the received identifier to locate other identifiers for personalization items associated with the submitted identifier.

Thereafter, the host system 110 replies to the IM sender system 105 with the personalization item(s) corresponding to the submitted identifier(s) (step 1030), and the IM sender system 105 renders the personalization item(s) (step 1035). Upon receipt of personalization items from the host system 110, the IM sender system 105 save the personalization item(s) in a memory or other storage at the local IM sender system 105 (e.g., it may cache them for future access/display).

The relative order of steps 1005-1035 with respect to other steps in procedure 1000, and also with respect to each other, may vary. Certain steps may be omitted entirely, as appropriate.

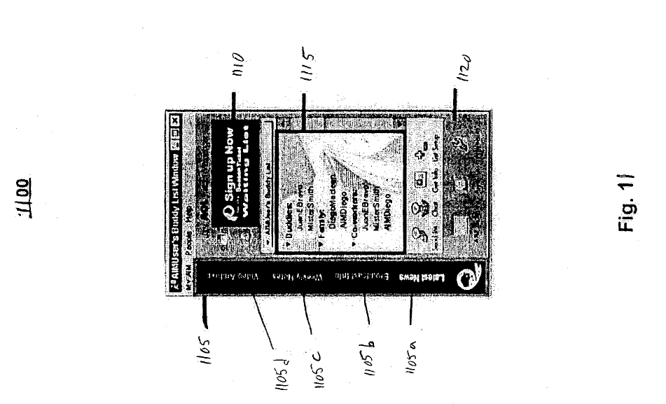

FIG. 11 is an example of an instant messaging buddy list UI 1100 that enables an IM sender of an instant messaging service to, among other things, perceive the presence state of other buddies that the IM sender has added to a buddy list, and to send instant messages to buddies on the buddy list. The buddy list may include personalization items such as a buddy list bar 1105, a buddy list image 1110, a buddy list background image 1115, and a buddy list fill pattern 1120 of the IM sender. The IM sender may select the personalization items manually, or the personalization items may be selected automatically for the IM sender. The personalization items may be rendered to the IM sender as described above with respect to procedure 1000.

The buddy list bar 1105 may contain personalized links 1105a, 1105b, 1105c, and 1105d to content and may have a customized appearance. The buddy list image 1110 and the buddy list background image 1115 may be, for example, image files from a remote source. The buddy list background image 1115 may have a washed out appearance. The buddy list fill pattern 1120 may be a color or pattern background for the buddy list, or may also be an image. One or more of these personalization items may be transmitted to an IM sender and rendered on the IM sender system 105. The transmission of the personalization items may occur during machine-to-machine communications that are not visible to the user.

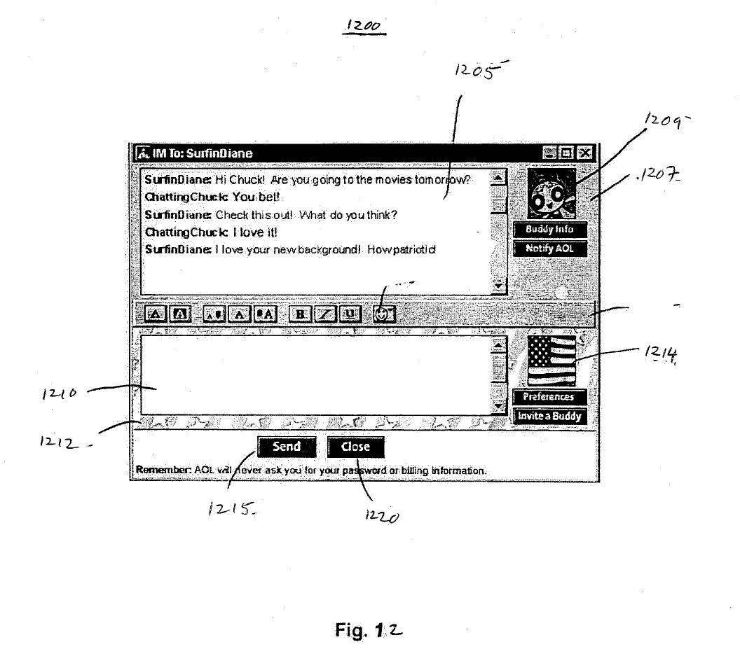

FIG. 12 illustrates one example of an IM UI 1200 that may be presented to an IM sender of an IM service provider such as the AOL Instant Messenger (AIM) service provided by America Online. In general, the UI 1200 is rendered on the IM sender system 105 using software stored on the IM sender system 105. One or more IM sender personalization items may be provided for the UI.

The UI 1200 includes an IM display area 1205 to display the messages 1205a of an active IM session. In the example of FIG. 12, the active IM session involves a conversation between the IM sender having a screen name of “ChattingChuck” and the IM recipient having a screen name of “SurfinDiane.” An IM compose area 1210 may be used to compose a message to send to the IM recipient in the active IM session, typically by clicking on the send control button 1215 in the UI. A control button 1220 may be provided to close the active IM session. Font and appearance controls may be provided on toolbar 1208 to control how the message being entered in the IM compose area 1210 is displayed in the IM display area 1205 once the message in the IM compose area 1210 is sent. For example, the IM sender may select control 1211 to choose a personalization item such as an emoticon to be sent in an IM message.

The UI 1200 includes personalization items 1207 and 1209 from the IM recipient and personalization items 1212 and 1214 from the IM sender.

As discussed above with respect to procedure 1000, the personalization items 1212 and 1214 of the IM sender may be rendered to the IM sender.

The IM sender system 105 uses the identifiers to determine if the corresponding personalization items are available locally at the IM sender system, and if so, the IM sender system retrieves the corresponding personalization items. If the personalization items are not available locally at the IM sender system 105, the IM sender system requests the personalization items from another location such as an IM host system 310 or another remotely-accessible data store. Once the IM sender system 105 locates or receives the personalization items, the IM sender system renders the items on UI 1200 for perception by the IM sender.

Similarly, IM wallpaper 1212 and a buddy icon 1214 chosen by the IM sender may be rendered in UI 1200. These items are typically stored locally on the IM sender system 105, and may be retrieved by the IM sender system 105. If an item is not stored locally, the IM sender system 105 may retrieve the personalization item from a different location such as, for example, an IM host 310. Once retrieved, the IM sender system 305 renders the IM wallpaper 1212 and the buddy icon 1214.

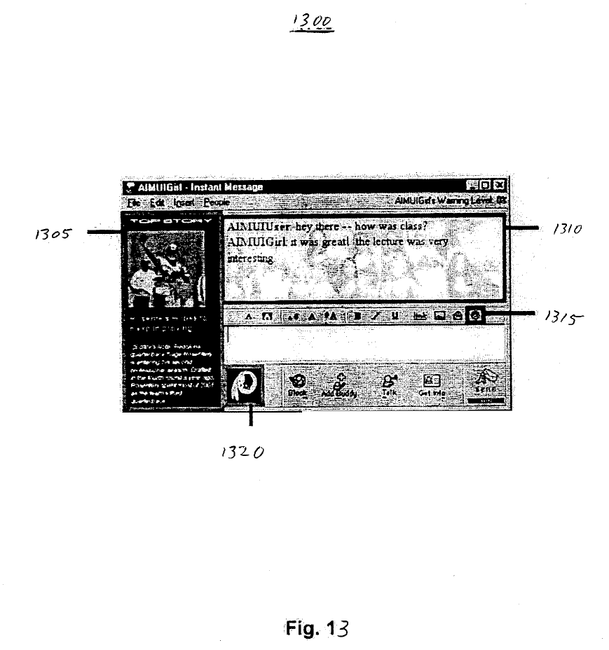

FIG. 13 illustrates yet another example of an IM UI 1300 that may be presented to an IM sender of an IM service provider such as the AOL Instant Messenger (AIM) service provided by America Online. One or more personalization items may be provided for the IM UI. The IM sender may select the personalization items manually, or the personalization items may be selected automatically for the IM sender. The personalization items may be rendered to the IM sender as described above with respect to procedure 1000.

In the example of FIG. 13, an IM sender “AIMMUIUSER” may provide a sidebar image 1305, a background image 1310, a buddy icon 1320, and a sound to be rendered by the IM sender system. The sidebar image 1305 may include images and links to content. The background image 1310 may include an image, and typically is a washed out image. The buddy icon 1320 typically also is an image. The sound 1325 may be a sound or a sequence of sounds played to the IM sender.

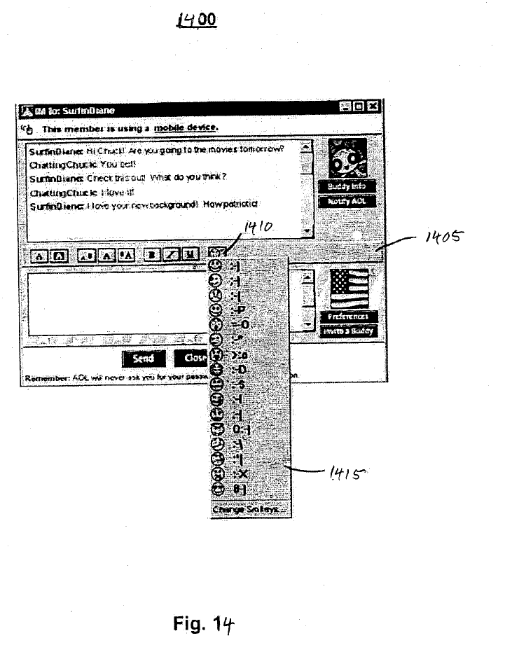

FIG. 14 illustrates an instant messaging UI 1400. In the example of FIG. 14, an IM sender is presented with a control bar 1405 that includes a drop down control 1410. When activated, drop down control 1410 causes the display of a drop down menu 1415 that shows the IM sender's current selection of smiley theme personalization items.

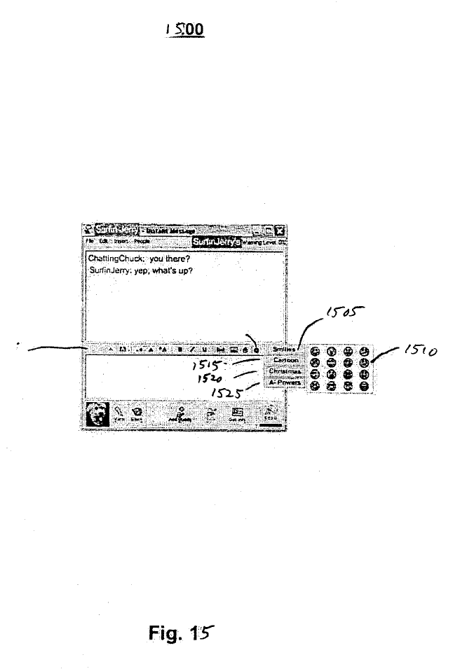

FIG. 15 is an example of an instant messaging UI 1500 and further illustrates the UI discussed above with respect to FIG. 14. In the example of FIG. 15, the drop down control 1410, when activated, causes the display of sub-menus 1505, 1515, 1520, and 1525. Each sub-menu enables the IM sender to select various personalization items. For example, sub-menu 1505, when selected, causes the display of menu 1510 for enabling the IM sender to select a smiley personalization item.

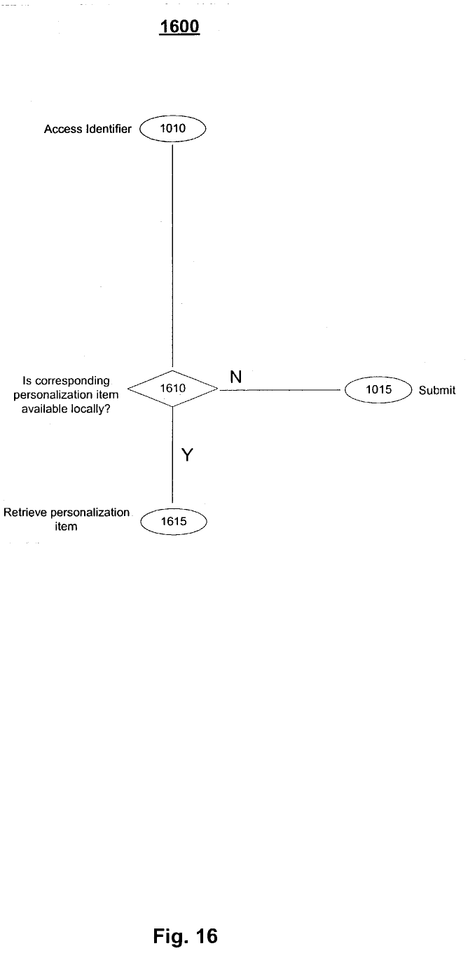

Referring to FIG. 16, procedure 1600 illustrates one possible method for discerning between personalization items to be retrieved locally by the IM sender system 105 and items to be retrieved remotely from the IM sender system. In procedure 1600, after the IM sender system accesses identifier(s) associated with possible personalization items to be rendered (1010, see procedure 1000), the IM sender system 105 determines whether the corresponding personalization item is available locally (step 1610). For example, the IM sender system 105 may have stored the corresponding personalization in a local memory or another local storage location, and the identifier may specify or be otherwise useful in determining the location at which the corresponding personalization item is stored.

If the corresponding personalization item is not available locally, the IM sender system 105 submits the identifiers to the appropriate host (step 1015), as described above with respect to procedure 1000.

If the corresponding personalization item is available locally, the IM sender system retrieves the corresponding personalization item (step 1615), and then renders the personalization item (step 1035) as described above with respect to procedure 1000.

In another implementation, the host is first interrogated as to whether the corresponding personalization item is located on the host. In another implementation, a list is maintained and a search is performed on the list or on a known directory or location.

In one implementation, the IM recipient and/or the IM sender may pay a subscription fee to access/use certain personalization items, and the personalization items may be provided by a third party. In another implementation, the personalization items expire and must be replaced after a predetermined event such as a predetermined length of time, passage of a predetermined date, or a predetermined number of uses. Also, a personalization item may be banned if, for example, it is deemed to be offensive, inappropriate, or to otherwise violate a term of service agreement. If it is determined that the personalization item is expired or banned, display of such a personalization item will be disallowed and the user typically will be required to choose a different personalization item.

Other implementations are within the scope of the following claims. For example, one identifier could correspond to a group of personalization items, or a personalization item could have more than one identifier. As a further example, although the examples above are given in an instant message context, other communications systems with similar attributes may be used. For example, personalization items may be used in a chat room or in e-mail communications. Also, the user interface may be a viewable interface, an audible interface, a tactile interface, or any combination of these.

What is claimed is:

1. A computer implemented method for enabling perception of a personalization item in an instant messaging communications session, the method comprising:
storing on a host system one or more personalization items associated with an instant messaging application operator;
receiving a request from an instant messaging participant system for the personalization items associated with the instant messaging application operator;
accessing the personalization items at the host system; and
communicating the personalization items from the host system to the instant messaging participant system for rendering in an instant messaging application running on the instant messaging participant system.

2. The method of claim 1 in which receiving the request comprises:
receiving an identifier enabling identification of a personalization item associated with the instant messaging application operator.

3. The method of claim 1 in which receiving the request comprises receiving an identity of the instant messaging participant; and
accessing the personalization items comprises accessing the personalization items associated with the received identity.

4. The method of claim 2 in which receiving the identifier further comprises receiving an identifier comprising a location on the host system of the personalization item.

5. The method of claim 4 in which the identifier further comprises an item type and a data size.

6. The method of claim 4 wherein the identifier further comprises one or more of a custom item flag, an official item flag, a banned item flag, and a redirect to different item flag.

7. The method of claim 1 in which the host comprises a server authorized as a partner to an instant messaging host.

8. The method of claim 1 in which storing the personalization items comprises storing a graphic.

9. The method of claim 8 in which the graphic comprises an icon.

10. The method of claim 1 in which storing the personalization items comprises storing a sound.

11. The method of claim 1 in which storing the personalization items comprises storing wallpaper capable of being rendered on an instant messaging application user interface.

12. The method of claim 1 in which storing the personalization items comprises storing an animation sequence.

13. The method of claim 1 in which storing the personalization items comprises storing a video segment.

14. The method of claim 1 in which in which storing the personalization items comprises storing a personalization item configured to expire upon the occurrence of a predetermined event.

15. The method of claim 14 in which the predetermined event comprises passage of a predetermined length of time or the passage of a predetermined date.

16. The method of claim 14 in which the predetermined event comprises a predetermined number of uses.

17. The method of claim 14 further comprising:
determining whether the personalization item has expired, and
disallowing access to the personalization item if the personalization item has expired.

18. The method of claim 1 further comprising:
determining whether the personalization item has been banned, and
disallowing access to the personalization item if the personalization item has been banned.

19. The method of claim 1 further comprising creating an identifier for a personalization item based upon the application of an algorithm to at least a portion of data comprising the item.

20. The method of claim 19 further comprising determining if the personalization item is stored at the host system based upon the identifier; and, if the personalization item is stored at the host system, declining to redundantly store the personalization item at the host system.

21. The method of claim 20 further comprising determining whether the personalization item is an official item based upon the identifier; and displaying the personalization item if the personalization item is an official item.

22. A computer program stored on a computer readable medium, the computer program comprising instructions for:
storing on a host system one or more personalization items associated with an instant messaging application operator;
receiving a request from an instant messaging participant system for the personalization items associated with the instant messaging application operator;
accessing the personalization items at the host system; and
communicating the personalization items from the host system to the instant messaging participant system for rendering in an instant messaging application running on the instant messaging participant system.

23. The computer program of claim 22 in which instructions for receiving the request comprises instructions for receiving an identifier enabling identification of a personalization item associated with the instant messaging application operator.

24. The computer program of claim 22 in which instructions for receiving the request comprises instructions for receiving an identity of the instant messaging participant; and
instructions for accessing the personalization items comprises instructions for accessing the personalization items associated with the received identity.

25. The computer program of claim 22 in which instructions for storing the personalization items comprises instructions for storing a graphic.

26. The computer program of claim 22 in which instructions for storing the personalization items comprises instructions for storing a sound.

27. The computer program of claim 22 in which instructions for storing the personalization items comprises instructions for storing wallpaper capable of being rendered on an instant messaging application user interface.

28. The computer program of claim 22 in which instructions for storing the personalization items comprises instructions for storing an animation sequence.

29. The computer program of claim 22 in which instructions for storing the personalization items comprises instructions for storing a video segment.

30. The computer program of claim 22 in which in which instructions for storing the personalization items comprises instructions for storing a personalization item configured to expire upon the occurrence of a predetermined event.

31. The computer program of claim 30 in which the predetermined event comprises passage of a predetermined length of time or the passage of a predetermined date.

32. The computer program of claim 30 in which the predetermined event comprises a predetermined number of uses.

33. A computer implemented method for enabling perception of a personalization item in an instant messaging communications session, the method comprising:
rendering, on an instant messaging participant system, an instant messaging application user interface for an instant messaging communications session involving at least an instant messaging application operator and another instant messaging participant;
identifying personalization items associated with the instant messaging application operator that are located external to the instant messaging participant system; and
communicating personalization items associated with the instant messaging application operator to the instant messaging participant system.

34. The method of claim 33 in which identifying the personalization items further comprises identifying a remote source location for the personalization items.

35. The method of claim 33 in which identifying the personalization items further comprises identifying the personalization items located on an instant messaging host.

36. The method of claim 33 in which identifying the personalization items comprises identifying a graphic.

37. The method of claim 36 in which the graphic comprises an icon.

38. The method of claim 33 in which identifying the personalization items comprises identifying a sound.

39. The method of claim 33 in which identifying the personalization items comprises identifying wallpaper capable of being rendered on an instant messaging application user interface.

40. The method of claim 33 in which identifying the personalization items comprises identifying an animation sequence.

41. The method of claim 33 in which identifying the personalization items comprises identifying a video segment.

42. The method of claim 33 in which identifying the personalization items comprises identifying a customized binary object uploaded by the instant messaging participant to a server.

43. The method of claim 33 in which identifying the personalization items comprises identifying a personalization item enabled to be rendered in consideration of a payment for such rendering.

44. The method of claim 33 in which in which identifying the personalization items comprises identifying a personalization item configured to expire upon the occurrence of a predetermined event.

45. The method of claim 44 in which the predetermined event comprises passage of a predetermined length of time or the passage of a predetermined date.

46. The method of claim 44 in which the predetermined event comprises a predetermined number of uses.

47. The method of claim 44 further comprising:
determining whether the personalization item has expired, and
disallowing display of the personalization item if the personalization item has expired.

48. The method of claim 33 further comprising:
determining whether the personalization item has been banned, and
disallowing display of the personalization item if the personalization item has been banned.

49. The method of claim 33 further comprising updating the personalization item.

50. The method of claim 33 in which communicating personalization items comprises:
obtaining an identifier enabling identification of a personalization item associated with the instant messaging application operator;
obtaining the personalization item from a source other than a message used to obtain the identifier; and
rendering the personalization item at the instant messaging participant system.

51. The method of claim 50 in which obtaining the identifier comprises:
sending an identity of the instant messaging participant to an instant messaging host system; and
receiving one or more identifiers in a message from the instant messaging host system, the identifiers being associated at the instant messaging host system with one or more personalization items, the personalization items being associated with the identity of the instant messaging participant.

52. The method of claim 50 in which obtaining the identifier comprises retrieving the identifier from a remote data store.

53. The method of claim 50 in which obtaining the identifier comprises receiving the identifier upon a change in a presence state of the instant messaging participant.

54. The method of claim 50 further comprising obtaining a location of the personalization item with the identifier.

55. The method of claim 54 in which the identifier further comprises an item type and a data size.

56. The method of claim 54 wherein the identifier further comprises one or more of a custom item flag, an official item flag, a banned item flag, and a redirect to a different item flag.

57. The method of claim 50 in which obtaining the personalization item comprises:
obtaining an identifier enabling identification of a personalization item associated with the instant messaging application operator;
determining whether the personalization item associated with the received identifier is available at the instant messaging participant system;
retrieving the personalization item from the instant messaging participant system if the personalization item is available at the instant messaging participant system; and
requesting the personalization item from a remote source and receiving the personalization item from the remote source at the instant messaging participant system if the personalization item is not available at the instant messaging participant system.

58. The method of claim 57 in which requesting the personalization item further comprises identifying the remote source.

59. The method of claim 57 in which requesting the personalization item comprises requesting the personalization item from an instant messaging host.

60. The method of claim 33 further comprising creating an identifier for a personalization item based upon the application of an algorithm to at least a portion of data comprising the item.

61. The method of claim 60 wherein creating an identifier comprises creating an identifier for a personalization item stored at the instant message participant system.

62. The method of claim 60 further comprising determining if the personalization item is stored at the host system based upon the identifier; and, if the personalization item is stored at the host system, declining to redundantly store the personalization item at the host system.

63. The method of claim 62 further comprising determining whether the personalization item is an official item based upon the identifier; and displaying the personalization item if the personalization item is an official item.

64. A computer program stored on a computer readable medium, the computer program comprising instructions for:
rendering, on an instant messaging participant system, an instant messaging application user interface for an instant messaging communications session involving at least an instant messaging application operator and another instant messaging participant;
identifying personalization items associated with the instant messaging application operator that are located external to the instant messaging participant system; and
communicating personalization items associated with the instant messaging application operator to the instant messaging participant system.

65. The computer program of claim 64 in which instructions for identifying the personalization items further comprises instructions for identifying a remote source location for the personalization items.

66. The computer program of claim 64 in which instructions for identifying the personalization items further comprises instructions for identifying the personalization items located on an instant messaging host.

67. The computer program of claim 64 in which instructions for identifying the personalization items comprises instructions for identifying a graphic.

68. The computer program of claim 64 in which instructions for identifying the personalization items comprises instructions for identifying a sound.

69. The computer program of claim 64 in which instructions for identifying the personalization items comprises instructions for identifying wallpaper capable of being rendered on an instant messaging application user interface.

70. The computer program of claim 64 in which instructions for identifying the personalization items comprises instructions for identifying an animation sequence.

71. The computer program of claim 64 in which instructions for identifying the personalization items comprises instructions for identifying a video segment.

72. The computer program of claim 64 in which instructions for identifying the personalization items comprises instructions for identifying a customized binary object uploaded by the instant messaging participant to a server.

73. The computer program of claim 64 in which in which instructions for identifying the personalization items comprises instructions for identifying a personalization item configured to expire upon the occurrence of a predetermined event.

74. The computer program of claim 73 in which the predetermined event comprises passage of a predetermined length of time or the passage of a predetermined date.

75. The computer program of claim 73 in which the predetermined event comprises a predetermined number of uses.

76. The computer program of claim 73 further comprising instructions for:
determining whether the personalization item has expired, and
disallowing display of the personalization item if the personalization item has expired.

77. The computer program of claim 64 further comprising instructions for:
determining whether the personalization item has been banned, and
disallowing display of the personalization item if the personalization item has been banned.

78. The computer program of claim 64 in which communicating personalization items comprises instructions for:
obtaining an identifier enabling identification of a personalization item associated with the instant messaging application operator;
obtaining the personalization item from a source other than a message used to obtain the identifier; and
rendering the personalization item at the instant messaging participant system.

79. The computer program of claim 78 in which instructions for obtaining the identifier comprises instructions for:
sending an identity of the instant messaging participant to an instant messaging host system; and
receiving one or more identifiers in a message from the instant messaging host system, the identifiers being associated at the instant messaging host system with one or more personalization items, the personalization items being associated with the identity of the instant messaging participant.

80. The computer program of claim 78 in which instructions for obtaining the identifier comprises instructions for retrieving the identifier from a remote data store.

81. The computer program of claim 78 in which instructions for obtaining the identifier comprises instructions for receiving the identifier upon a change in a presence state of the instant messaging participant.

82. The computer program of claim 78 further comprising instructions for obtaining a location of the personalization item with the identifier.

83. The computer program of claim 82 in which the identifier further comprises an item type and a data size.

84. The computer program of claim 82 wherein the identifier further comprises one or more of a custom item flag, an official item flag, a banned item flag, and a redirect to a different item flag.

85. The computer program of claim 78 in which instructions for obtaining the personalization item comprises instructions for:
obtaining an identifier enabling identification of a personalization item associated with the instant messaging application operator;
determining whether the personalization item associated with the received identifier is available at the instant messaging participant system;
retrieving the personalization item from the instant messaging participant system if the personalization item is available at the instant messaging participant system; and
requesting the personalization item from a remote source and receiving the personalization item from the remote source at the instant messaging participant system if the personalization item is not available at the instant messaging participant system.

86. The computer program of claim 85 in which instructions for requesting the personalization item comprises instructions for requesting the personalization item from an instant messaging host.

87. The computer program of claim 54 further comprising instructions for creating an identifier for a personalization item based upon the application of an algorithm to at least a portion of data comprising the item.

88. The computer program of claim 87 wherein instructions for creating an identifier comprises instructions for creating an identifier for a personalization item stored at the instant message participant system.

89. The computer program of claim 87 further comprising instructions for determining if the personalization item is stored at the host system based upon the identifier; and, if the personalization item is stored at the host system, declining to redundantly store the personalization item at the host system.

90. The computer program of claim 89 further comprising instructions for determining whether the personalization item is an official item based upon the identifier; and displaying the personalization item if the personalization item is an official item.
